(19) United States
(12) Patent Application Publication
(10) Pub. No.: US 2007/0284774 A1
(43) Pub. Date: Dec. 13, 2007

(54) Method and system for automated purging of manufacturing systems

(75) Inventors: Francisco Bautista Sandoval, Zapopan (MX); Enrique Villasenor Murillo, Tonala (MX); Manuel Valencia Lopez, Guadalajara (MX)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: TECHNICOLOR INC.

(21) Appl. No.: 11/448,399

(22) Filed: Jun. 7, 2006

(51) Int. Cl. B28B 7/04; G06F 17/00

(52) U.S. Cl. 264/39; 264/169; 700/90

(57) ABSTRACT

The present invention provides a method and system for automatically purging a production system. A system and method for automatically purging a manufacturing and production system includes a production device configured to purge production material during a purging period, and a control system configured to determine a quantity of production material to be purged based upon historical data corresponding to operating conditions relevant to production, wherein the control system compares current production operating conditions to the historical data to determine a purging period and to determine when production should resume. The production system and method can further include at least one sensor configured to determine at least one of whether impurities and degradations exist in the purged production material and operating conditions of the production system.

### FIELD OF THE INVENTION

The present invention relates generally to manufacturing systems, including injection molding systems, and, more particularly, to a system and method which includes an automatic purge system which reduces waste and provides improved quality control.

### BACKGROUND OF THE INVENTION

Injection molding systems which are used to create optical disks usually include more than one injection molding machine. The injection molding machines form clear substrates used in the manufacture of optical disks, such as DVDs, CDs or other plastic media. In a system where two or more injection molders are used, it is often difficult to ensure that all machines have been purged adequately before product is made.

Purging in molding machines refers to a startup process that bleeds molten plastic from an extruder or other port to “purge” air or impurities that may be present in supply lines or molding equipment. Purging includes running the molding machine until the plastic being ejected is free from impurities and air bubbles. The impurities can include burnt plastic, dirt, rust, dust or any other residue or material that could comprise the product quality.

Purging is typically a manual process, which means an operator visually inspects the purged material until the plastic is clear without impurities, material degradation or visible air bubbles. In a production line where two or more injection molding machines may be integrated, manually inspecting each machine may become inconvenient and time consuming since each purge port must be visually inspected prior to the final production of product. In addition, the observation of the purge material becomes subjective and depends on the experience and vision of the operators (e.g., different operators may see different things in the purged material). Furthermore, operators generally purge more material than necessary to be on the safe side and to ensure that impurities and air have been eliminated.

The purging process also needs to be performed in the event of a shut down. A shut down may occur as the result of reduced quality in the molded product, machine failure or any other event. After the shut down, the molding machines may need to be purged again prior to startup.

### SUMMARY OF THE INVENTION

The present invention provides a method and system for automatically purging a manufacturing and production system.

In one embodiment of the present invention, a method for purging a production line includes determining an amount of production material to be purged, purging the production line in accordance with the determined amount of production material to be purged, and resuming production after the purging. The method can optionally further include monitoring the production line to determine at least one of a quantity and a quality of the production material in the production line or monitoring production conditions to determine an amount of production material to be purged, where the production conditions include at least one of temperature, humidity and production down time.

In an alternate embodiment of the present invention a method for purging an injection molding system includes determining a quantity of molding material to be purged based upon historical data corresponding to conditions relevant to production, purging molding material in accordance with the determined quantity, and automatically resuming production after the purging. The method can optionally further include monitoring the purged molding material to determine whether impurities or degradations exist in the purged molding material to ultimately determine a quantity of molding material to be purged.

In an alternate embodiment of the present invention, a production system includes a production device configured to purge production material during a purging period, and a control system configured to determine a quantity of production material to be purged based upon historical data corresponding to operating conditions relevant to production, wherein the control system compares current production operating conditions to the historical data to determine a purging period and to determine when production should resume. The production system can further include at least one sensor configured to determine at least one of whether impurities or degradations exist in the purged production material and operating conditions.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for automatically determining purge cycle time in accordance with one embodiment of the present invention;

FIG. 2(a) depicts a diagram of temperature considerations for adjusting a number of shots or quantity of purge material to ensure an acceptable final product in accordance with an embodiment of the present invention;

FIG. 2(b) depicts a diagram of humidity considerations for adjusting a number of shots or quantity of purge material to ensure an acceptable final product in accordance with an embodiment of the present invention;

FIG. 3 depicts a plot of shots versus time used in defining conditions under which purging is continued or when production may begin in accordance with an embodiment of the present invention;

FIG. 4 depicts a block/flow diagram of a method for automatically determining a duration of a purge cycle in accordance with an embodiment of the present invention;

FIG. 5 depicts a block/flow diagram of a method for automatically determining a duration of a purge cycle in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention addresses the deficiencies of the prior art by advantageously providing a system and method for automatically purging production processes. Although the present invention will be described primarily within the context of a disk manufacturing system, the specific embodiments of the present invention should not be treated as limiting the scope of the invention. It will be appreciated by those skilled in the art and informed by the teachings of the present invention that the concepts of the present invention can be advantageously applied in substantially any production system (including any injection or other molding system) that utilizes a production cycle where the quality and/or quantity of the output is monitored such as plastic molding production systems including but not limited to, DVD (Digital Video Discs) manufacturing processes, compact disk (CD) manufacturing processes, etc. It will thus be appreciated that those skilled in the art will be able to devise various arrangements that, although not explicitly described or shown herein, embody the principles of the invention and are included within its spirit and scope.

By automating the purging process in accordance with the present invention, human subjectivity is eliminated and waste is reduced. In addition, better control over the production process is achieved. In addition to the purging process becoming more repeatable and consistent, purge waste is reduced since the quantity of purge material is automatically controlled. In various embodiments of the present invention as described below, automation enables devices with higher sensitivity than the human eye which are employed to determine when the purged material no longer includes impurities or air bubbles, and can do so with greater confidence than a human operator. This reduces down time for the production line and reduces purge waste.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Moreover, the functions of the various elements shown in the figures may be provided through the use of dedicated hardware as well as hardware capable of executing appropriate software in association with the hardware. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

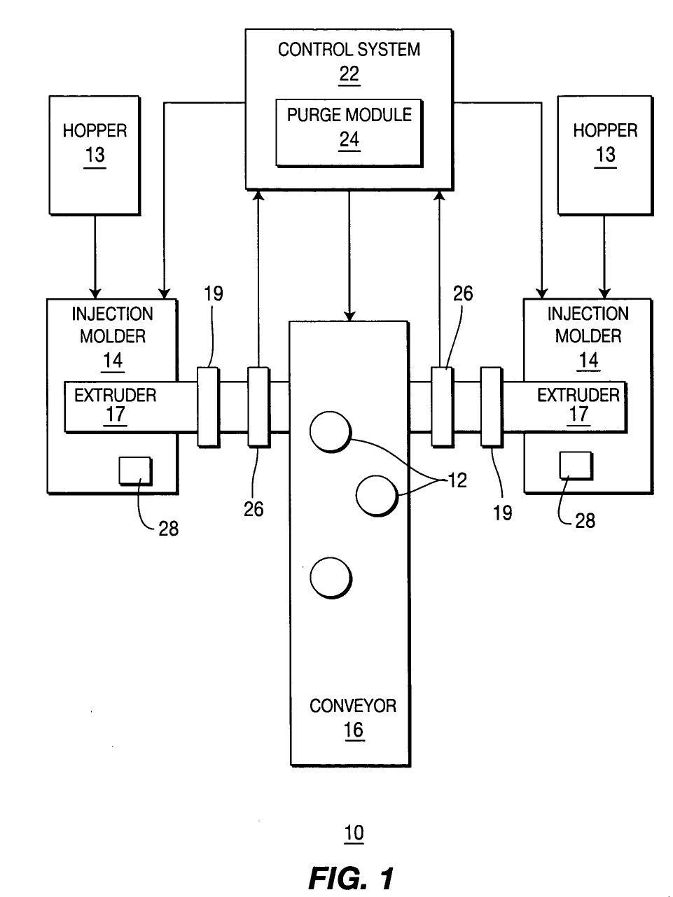

FIG. 1 depicts a high level block diagram of a disk manufacturing system for automatically determining purge cycle time in accordance with one embodiment of the present invention. In FIG. 1, an illustrative disk manufacturing system 10 comprises production devices, illustratively injection molders 14, including automatic purge control capabilities to reduce plastic (e.g., polycarbonate) waste in a production setting such as for a DVD manufacturing process. Details of the individual block components making up the system architecture are known to skilled artisans, and will only be described in details sufficient for an understanding of the present invention.

System 10 of FIG. 1 includes one or more injection molders 14. Injection molders 14 are known in the art. Injection molders 14 include a mold 19, which is used to mold plastic. The plastic is fed into a hopper 13 and heated to a molten or liquefied state. The plastic is extruded by an extruder 17 which provides pressure to force the molten plastic into a mold. The mold, which is typically split in half and held together by robotic arms or other mechanical devices, is cooled. When the mold is closed, the extruder rapidly delivers molten plastic into the cooled mold or molds. The molten plastic is cooled in the mold and solidifies. The mold 19 is then opened and the plastic in the form of, for example, a disk 12 is released.

In such disk manufacturing systems as the disk manufacturing system 10 of FIG. 1, different systems can have varying locations for purging plastic (e.g., production material). A purge port can be included at a plurality of different places of the disk manufacturing system 10 such as directly adjacent to the extruder 17, in the mold 19, or at any other location in the supply line for molten or liquefied plastic. For simplicity, the purge material described herein is the material output from the molds 19 during a purging period or process. Typically, the purged material takes the form of the production material itself (commonly referred to as a shot), for example, an optical disk 12 in the disk manufacturing system 10 of FIG. 1.

At start up, a number of shots (e.g., disks 12) are initially manufactured in order to purge the manufacturing system 10. The shots (production material) are deposited on a conveyor 16 for examination. A scanner or other inspection device in accordance with the present invention can include an optical scanning system and programs to examine the presence of disks 12 on conveyor 16, and/or to examine the quality of the disks 12 on the conveyor 16. Illustratively, a control system 22 in the disk manufacturing system 10 of FIG. 1 provides operational commands to each piece of equipment in the manufacturing system 10. The control system 22 can include one or more computers or computer systems which monitor system parameters to determine if any problems or issues exist or to monitor the quality of the output of, for example, the injection molders 14.

The control system 22 of FIG. 1 illustratively includes a purge module 24, which may include programs and/or hardware that control purge operations in the manufacturing system 10. Alternatively, the purge module 24 can be distributed across the manufacturing system 10, for example, in each injection molder 14 depicted by modules 28. The control system 22 stores/provides set points and settings for automatically ending a purge cycle. The control system 22 includes information from a plurality of sources which is used to determine the time needed for purging based upon present criteria or in-situ measurements. The purge cycle of the present invention saves plastic (e.g., polycarbonate) waste and assures standard start-up settings for the molding machine and production line. The manufacturing system 10 of the present invention reduces the down time of the injection molding machines by calculating and measuring, automatically, the optimum number of purge shots for avoiding material degradations and problems associated with air in the supply lines.

In prior art disk manufacturing systems, the purge quantity (number of shots) is evaluated by an operator through visual inspection. A production line reaches a start readiness state when the purge production material is made without air bubbles or degradation problems (dark colored material or impurities). In accordance with the present invention, the control system 22 of the disk manufacturing system 10 of FIG. 1 stores production criteria, historic data and/or real-time measurements to determine when the purge cycle should end and when normal production can begin. The following description will describe some illustrative information sources that may be employed with the purge system in accordance with aspects of the present invention. For example, one source of information can include empirical data that relates to present manufacturing conditions to an amount of time that purging needs to undergo.

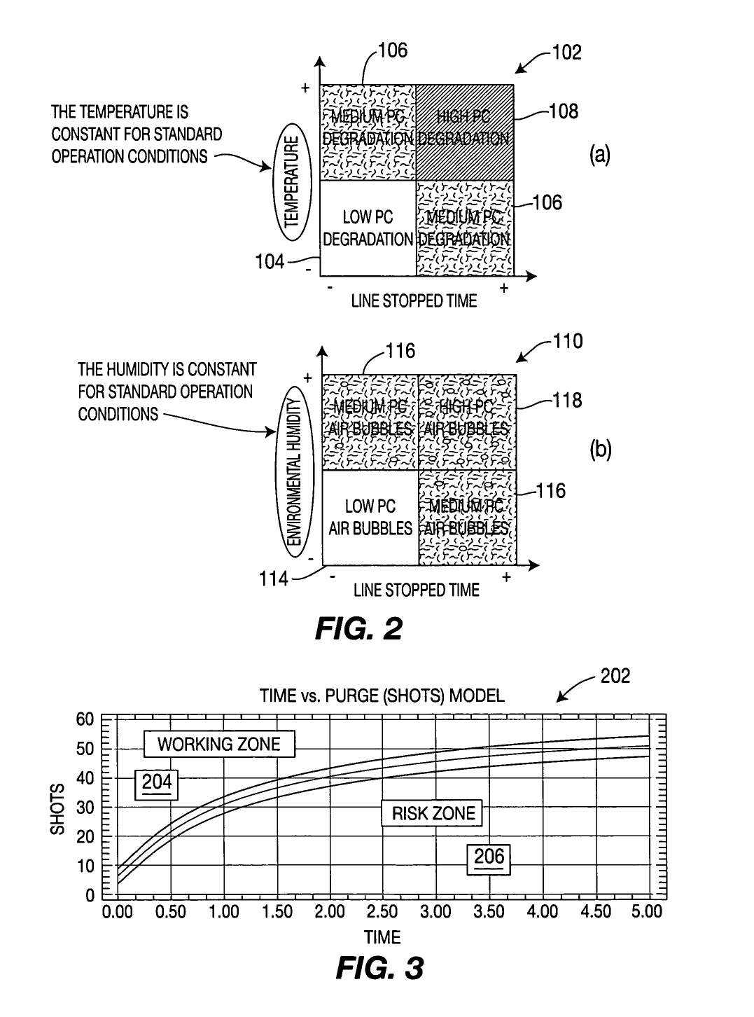

FIG. 2(a) depicts a diagram of temperature and humidity considerations for adjusting a number of shots or quantity of purged production material to ensure an acceptable final product in accordance with an embodiment of the present invention. In FIG. 2(a), the diagram 102 illustratively depicts temperature on the y-axis and line stopped time (i.e., relative time that production line is shut down) on the x-axis. As depicted in FIG. 2(a), a number of shots or the amount of time needed to purge the molders increases with temperature and similarly, with the amount of time that the system is inactive (stop time). Diagram 102 depicts a region 104 with low material degradation, regions 106 with medium material degradation and region 108 with high material degradation. Since the manufacturing system 10 is normally run under known operational temperatures, an amount of time (or number of shots) for purging can be determined based on a current operating temperature and historical manufacturing experience.

FIG. 2(b) depicts a diagram of humidity considerations for adjusting a number of shots or quantity of purge material to ensure an acceptable final product in accordance with an embodiment of the present invention. In FIG. 2(b), the diagram 110 illustratively depicts humidity on the y-axis and line stopped time on the x-axis. As depicted in FIG. 2(a), a number of shots, or the amount of time needed to purge the molders, increases with humidity and similarly, with the amount of time that the system is inactive (stop time). Diagram 110 shows a region 114 with low material degradation, regions 116 with medium material degradation and region 118 with high material degradation. Again, because the manufacturing system 10 is run under known operational humidity, an amount of time (or number of shots) for purging can be determined based on a current operating humidity and historical manufacturing experience.

In accordance with the present invention various other operating conditions can be taken into account to determine an amount of time (or number of shots) for purging. For example, such other conditions that can be considered include historical data regarding the volume of production material or number of shots needed in the purge cycle before production can begin depending on current operating conditions.

For example, FIG. 3 depicts a plot of shots (amount of purged production material) versus time used in defining conditions under which purging is continued or when production may begin in accordance with an embodiment of the present invention. Plot 202 of FIG. 3 plots historical data relating a number of shots and time elapsed from the beginning of a purge cycle. The data creates a working zone region 204 and a risk zone region 206 as depicted in FIG. 3. The purge cycle can be stopped when the production line achieves the conditions in the working zone region 204, but continues purging when conditions remain in the risk zone region 206. It should be understood that, in accordance with the present invention, other manufacturing conditions or criteria can be plotted in addition to or instead of the illustrative information included in the plot 202 of FIG. 3. In addition, in alternate embodiments of the present invention a plurality of plots can be provided for different environmental conditions or manufacturing criteria to determine an amount of production material to be purged or a purge period.

Referring back to FIG. 1, in the manufacturing system 10 sensors 26 can be included at the output of each injection molder 14. These sensors 26 can comprise optical sensors, infrared sensors or any other sensors capable of resolving air bubbles, darker plastic, impurities, etc. in the purged material. The sensors 26 can also be capable of taking measurements, such as temperature, humidity or other conditions. The sensors 26 scan disks during the purge cycles to determine whether air bubbles or impurities of a certain size can be detected. Also the translucence of the purged material can be measured. The criteria for determining whether the purge cycle can be ended are preferably stored in the control system 22. During the purge cycle, a number of shots are output from the molders 14. The sensors 26 scan the disks 12 looking for imperfections (e.g., air bubbles) of, for example, a predetermined size or density. If the imperfections remain larger than a threshold size stored in, for example, the control system 22, the purge cycle continues. Otherwise, the purge cycle is ended and normal production can begin. Likewise, the translucence or color of the purged disks 12 can be compared to a standard. If the color is darker than the standard, the purge continues. Otherwise, the purge ends and normal production can begin.

The sensors 26 can include an illumination source (not shown) that illuminates the disks 12 to enhance air bubble reflections and/or highlights the color/clarity of the disks 12. As such, it can be determined using the automated equipment described in accordance with the present invention whether a purge cycle has completed and if normal production can begin. The images of the illuminated disks 12 can be compared to a data base of stored disk images and/or imperfections can be examined to determine if a number of detected imperfections is above or below a predetermined threshold. If the number of imperfections is below a threshold, the purge cycle can be ended. Otherwise the purge cycle can continue.

Alternatively or in addition, an elapsed time versus a number of shots can be determined and a purge cycle time can be determined based on historical data, (i.e., refer to FIG. 3). After a number of shots for a given period have been run, an assumption can be made based on historical data that the production cycle can begin and the purge process ends.

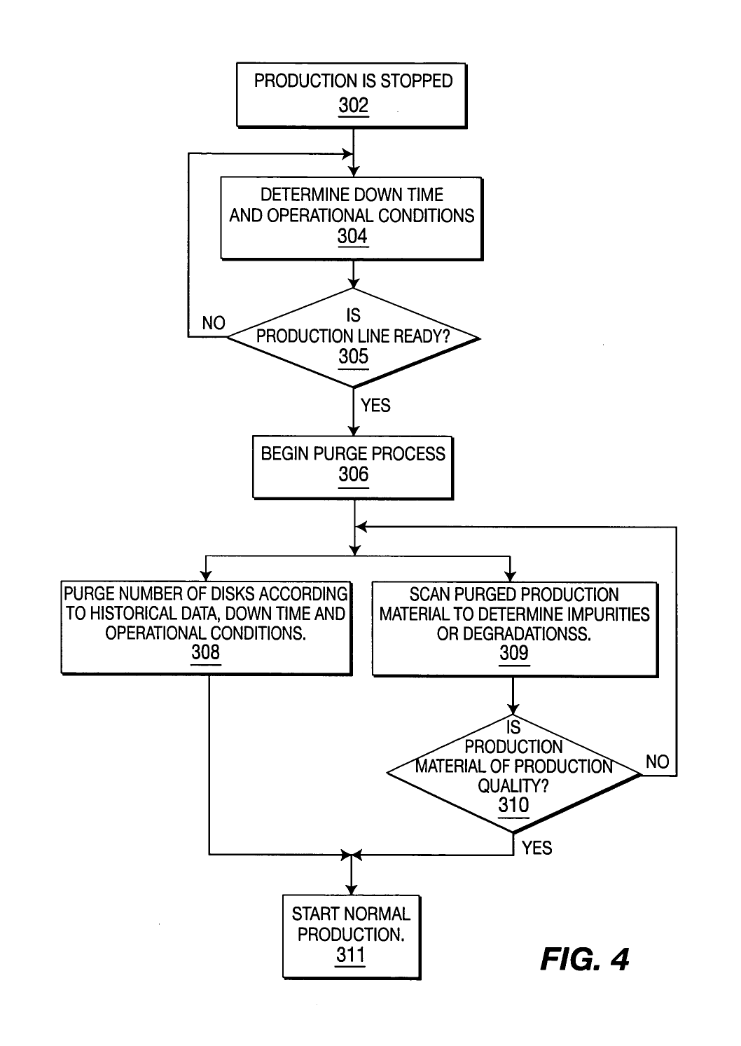

FIG. 4 depicts a block/flow diagram of a method for automatically determining an amount of production material to be purged (e.g., a duration of a purge process) in accordance with an embodiment of the present invention. Referring to FIG. 4, the method begins at step 302 where a replication or production line is stopped or is in a state prior to startup. During a period of inactivation, an elapsed time can be recorded for later use in determining a required purge period. The method then proceeds to step 304.

At step 304, an amount of down time and other conditions (e.g., environmental conditions) effecting purge settings are determined for later use in determining a purge period. That is, an initial determination or estimation can be made as to the purge settings (e.g., purge period and amount of production material to be purged) when down time and operational conditions are known as described above. The method then proceeds to step 305.

At step 305, a determination is made as to whether the production line of the manufacturing system is ready to begin. If the production line is not ready to begin, the method returns to step 304. If the production line is ready to begin, the method proceeds to step 306.

At step 306, a purge cycle is started. The method then proceeds to step 308 or alternatively to step 309.

At step 308, injection molders begin producing purge shots (purging production material). In accordance with one embodiment of the present invention, the number of purge shots can be predetermined based on the conditions and determinations made in step 304. For example, the injection molders can produce a number of shots in accordance with FIG. 3. When the “working zone” of FIG. 3 is achieved by the injection molder, the purge cycle is ended. In addition, the number of shots predetermined based on down time, environmental conditions, etc. made in step 304 can be modified based on current conditions or circumstances. That is, a recalculation can be performed automatically based upon measurements or preprogrammed criteria. When the predetermined number of purge shots (e.g., amount of production material) has been produced, the purge process is ended. The method then proceeds to step 311.

In an alternate embodiment of the present invention, at step 309, the shots (purge disks) being produced are scanned by the sensors to determine impurities or degradations in the production material (e.g., disks). The method of step 309 then proceeds to step 310.

At step 310 if it is determined that the shots (e.g., production materials) are, within a threshold, free from air bubbles, degradation and impurities, etc (i.e., production materials are of production quality), the purge process is ended and the method then proceeds to step 310. If it is determined that the shots contain an amount of degradation and impurities, etc. above a threshold (i.e., production materials are not of production quality), the purge process continues and the method returns to step 309.

It should be noted, however, that although in the embodiment of the present invention of FIG. 4, step 308 and steps 309 and 310 are depicted as alternative steps of the method of FIG. 4, in alternate embodiments of the present invention steps 308 and 309 can be used in any combination in accordance with the present invention.

At step 311, normal production is commenced.

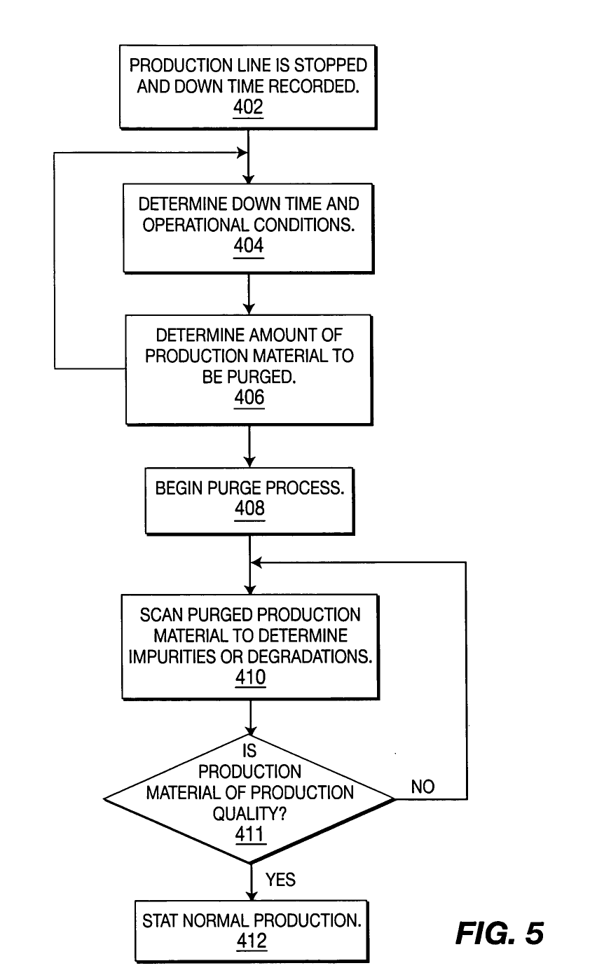

FIG. 5 depicts a block/flow diagram of a method for automatically determining an amount of production material to be purged (e.g., a duration of a purge process) in accordance with an alternate embodiment of the present invention. The method of FIG. 5 can be implemented as a software controlled process using the control system 22, FIG. 1 or alternatively can be implemented by the injection molders 14 which can be configured with at least processing capabilities to perform the method of FIG. 5. The process of FIG. 5 begins at step 402 where a production line has been stopped and a time elapsed since the stop is recorded. The method then proceeds to step 404.

At step 404, conditions effecting purge settings are determined for later use in determining a purge period. For example, a temperature measurement, a humidity measurement, elapsed time from stop and any other ambient conditions effecting a purge period or setting can be measured. Other ambient conditions may include dust content in the air, air movement, time of day, other processes occurring in the vicinity, etc. In addition, these conditions can be quantified based on the history of conditions that have occurred since shut down (i.e., based on intermittent measurements made during the elapsed time after shut down). These condition measurements are used to determine a number of purge shots that must be run prior to the start of normal production. These conditions can be used as modifiers on a minimum number of shots. For example, if the humidity is very high, x number of additional shots can be required. These determinations can be based on historical data regarding the environmental conditions and number of purge shots needed. For example, the quantity of the polycarbonate purge in a DVD process depends on polycarbonate degradation or air bubbles. Historical data can indicate that, for example, after 20 shots these imperfections are sufficiently diminished. The method then proceeds to step 406.

At step 406, the conditions described in step 404 are used to determine, based on at least historical information, an amount of production material to be purged or the duration of a purge process. In one embodiment of the present invention, a baseline number of shots is modified based on the measurement conditions of step 404. More specifically, a baseline number of shots can be determined via a table or graph (e.g., see FIG. 3), which uses historical data to determine a minimum number of shots needed to purge a manufacturing system and to then begin production. One or more models can be determined and applied to assure a minimum purge quantity (or purge process duration) such that when the purge process is complete no air bubbles or degradation problems (dark color) exist in production material to be produced during normal production.

In an alternate embodiment of the present invention, the conditional information ascertained in step 404 can be used to determine which table or graph to use (e.g., see FIG. 3). That is, a plurality of condition representations or graphs can be provided so that criteria are provided under a plurality of conditions. For example, given temperature and humidity a graph such as the graphs of FIG. 2(a) and FIG. 2(b) can be used to determine the number of shots needed for purging (amount of production material to be purged). Since temperature and humidity are often controlled in a manufacturing environment only one graph or representation may be needed. However, this depends on the application, and application-specific considerations. The method then proceeds to step 408.

At step 408, the purging process begins at the injection molders. The method then proceeds to step 410.

At step 410, the shots are scanned to determine the presence of air bubbles, material degradation, impurities, etc. This scanning, in the embodiment of the present invention of FIG. 5 is performed in addition to the determination of a minimum number of shots as set forth in steps 404 and 406. That is, the disks output from the injection molders are scanned to determine the size, number and/or characteristics of any existing imperfections. In the embodiment of the present invention of FIG. 5, a minimum number of shots is determined to assure that at least the determined minimum number of disks are purged and subsequently a determination to end the purge process is dependent on the scanning process. The method proceeds to step 411.

At step 411, the size and quantity of the imperfections and all other determined information relevant to the purge process (e.g., translucence of disk) is evaluated to determine a condition of the production material (e.g., the disk). The condition of the disk can then be compared to a threshold to determine if the disk is acceptable for normal production or if the purge process should continue. As described above, the threshold can be determined from stored information relevant to production material such as an image of an acceptable disk including acceptable imperfections or translucence. Even further, in accordance with the present invention, a minimum number of acceptable disks can be required before a purge process is ended. For example, it may be required for three disks to be acceptable in a row and for the minimum number of shots to have been produced (and/or time elapsed), before a purge process is ended and for normal production to begin. If the conditions for normal production are satisfied the method proceeds to step 412. If the conditions for normal production are not satisfied the method returns to step 410.

At step 412, normal production begins.

By providing a predictable purge cycle in accordance with the present invention, greater control of the process is enabled, waste is better controlled, down time and start up time can be predicted more reliably, and operator error can be reduced or eliminated.

Having described preferred embodiments for a method and system for automatically purging manufacturing and production systems (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof. As such, the appropriate scope of the invention is to be determined according to the claims, which follow.

1. A method for purging a production line, comprising:
determining an amount of production material to be purged;
purging said production line in accordance with the determined amount of production material to be purged; and
resuming production after said purging.

2. The method of claim 1, wherein determining the amount of production material to be purged comprises monitoring said production line to determine at least one of a quantity and a quality of said production material in said production line.

3. The method of claim 2, said production line is monitored to determine whether at least one of impurities and degradations remain in the production material being purged.

4. The method of claim 1, wherein production conditions are monitored to determine an amount of production material to be purged.

5. The method of claim 4, wherein said production conditions comprise environmental conditions of a production environment.

6. The method of claim 5, wherein said environmental conditions comprise at least one of temperature and humidity.

7. The method of claim 4, wherein said production conditions include a production down time.

8. The method of claim 1, wherein historical data is used to to determine an amount of production material to be purged.

9. A method for purging an injection molding system, comprising:
determining a quantity of material to be purged based upon historical data corresponding to production conditions;
purging molding material in accordance with said determined quantity; and
automatically resuming production after said purging.

10. The method of claim 9, wherein said conditions relevant to production comprise at least one of temperature, humidity and production down time.

11. The method of claim 9, wherein a quantity of material to be purged is further determined by monitoring said purged molding material to determine whether at least one of impurities and degradations exist in the purged molding material.

12. The method of claim 11, wherein said purging is ended and said production is resumed when an amount of impurities or degradations in said purged molding material fall below a threshold.

13. The method of claim 12, wherein said threshold comprises a stored image of molding material that is acceptable for normal production.

14. A production system, comprising:
a production device configured to purge production material during a purging period; and
a control system configured to determine a quantity of production material to be purged based upon historical data relating to production operating conditions, wherein said control system compares current production operating conditions to said historical data to determine a purging period and to determine when production should resume.

15. The production system of claim 14, wherein said operating conditions comprise at least one of temperature, humidity and production down time.

16. The production system of claim 14, further comprising at least one sensor configured to determine at least one of whether impurities or degradations exist in the purged production material and operating conditions.

17. The production system of claim 16, wherein said control system further determines a quantity of material to be purged by comparing information from said at least one sensor to stored information.

18. The production system of claim 17, wherein said stored information comprises data regarding production material that should be purged and production material that is acceptable for production.

19. The production system of claim 16, wherein said at least one sensor comprises an illumination source for illuminating said production material.
